(19) United States
(12) Patent Application Publication
(10) Pub. No.: US 2020/0188835 A1
(43) Pub. Date: Jun. 18, 2020

(54) Method For Removing Gaseous Contaminants From A Fluid Stream

(71) Applicant: Purafil, Inc., Doraville, GA (US)

(72) Inventor: William G. England, Doraville, GA (US)

(73) Assignee: Purafil, Inc., Doraville, GA (US)

(21) Appl. No.: 16/640,895

(22) PCT Filed: Aug. 23, 2018
(86) PCT No.: PCT/US2018/047682

§ 371 Date: Feb. 21, 2020

Related U.S. Application Data
(60) Provisional application No. 62/549,671, filed on Aug. 24, 2017.

(51) Int. Cl. B01D 53/02

(52) U.S. Cl. CPC B01D 53/02; B01D 2253/108; B01D 2253/25; B01D 2257/2025; B01D 2258/06; B01D 2257/304; B01D 2257/302; B01D 2257/404; B01D 2257/406; B01D 2257/204

(57) ABSTRACT

A method for removing contaminants from a fluid stream. More particularly, described herein is a method for removing ammonia and acid gas from an air flow. A method of making a metal zeolite impregnated fiber filter is also described. Also described herein is a method of monitoring the continued usefulness of a zeolite impregnated fiber filter.

### CROSS-REFERENCE TO RELATED APPLICATIONS

This application claims the benefit of U.S. Provisional Application No. 62/549,671, filed Aug. 24, 2017, which is incorporated herein by reference in its entirety.

### TECHNICAL FIELD

The present disclosure relates generally to methods for the removal of contaminants from a fluid stream and more specifically to the use of modified fiber filter media for removing one or more contaminant gases from an air flow and methods of fiber filter production.

### BACKGROUND

The removal of toxic, corrosive and odorous gases can be accomplished by a number of techniques. These may include wet scrubbing, incineration, and removal via gas-phase air filtration using a variety of dry scrubbing adsorptive, absorptive, and/or chemically impregnated media. As opposed to the other methods, gas-phase air filtration avoids the consumption of large quantities of water or fuel. Dry-scrubbing media can be engineered from a number of common adsorbent materials with or without chemical additives for the control of a broad spectrum of gases or tailored for specific gases.

In contrast to the reversible process of physical adsorption, chemical adsorption, also referred to as chemisorption, is the result of chemical reactions on the surface of the media. This process is specific and depends on the physical and chemical nature of both the media and the gases to be removed. Some oxidation reactions can occur spontaneously on the surface of the adsorbent, however, a chemical impregnate is typically added to the media. The impregnate imparts a higher contaminant removal capacity and has the ability to lend some degree of specificity. Although some selectivity is apparent in physical adsorption, selectivity can usually be traced to purely physical, rather than chemical, properties. In chemisorption, stronger molecular forces are involved, and the process is generally instantaneous and irreversible.

Airborne contaminant gases, particularly acid gases and/or ammonia gas, can emanate from the combustion of fossil fuels, acid rain, industrial processes, waste incineration, industrial accidents, and biological functions, to name a few. Because many people spend much of their time indoors, infiltration of contaminant gases into a contained area can increase the risk of exposure. Additionally, contaminant gases pose threats beyond health threats suffered by humans and animals. Contaminant gases can have deleterious effects on museum artifacts, historical documents, building structures, information technology machines, infrastructure and esthetic applications, to name a few.

Therefore, what is needed is air filtration media having a physical structure capable of adsorbing certain categories of contaminant gases and, impregnated thereon, a composition capable of absorbing multiple categories of undesirable contaminant gases. Additionally, what is needed is a method of monitoring the utility of the filtration media so it can be replaced when the capacity for contaminant gas capture becomes exhausted.

### SUMMARY

A method for removing one or more gaseous contaminants from a fluid stream, wherein the one or more gaseous contaminants include gaseous acids, is provided herein. In accordance with the method the fluid stream is contracted with a filtration medium containing a multi-layer fiber, wherein a first layer is a core and a second layer is a cladding, and an additive is disposed within the cladding layer. Also provided is a method of making additive impregnated multi-layer fibers by heating a first polymer to form a first polymer melt; extruding the first polymer melt to form a first polymer fiber; heating a second polymer to form a second polymer melt; mixing an additive including a metal zeolite into the second polymer melt to form an additive-containing polymer melt; and extruding the additive-containing polymer melt about the first polymer fiber to form an additive-containing fiber layer, wherein the first polymer fiber is a core and the additive-containing fiber layer is a cladding. Further provided is a method for analyzing the ability of an unconverted metal zeolite of a filtration medium to continue to remove gaseous acids from a fluid stream, wherein the filtration medium includes a multi-layer fiber, wherein a first layer is a core and a second layer is a cladding, and an additive is disposed within the cladding layer, by contacting the filtration medium with a reactant and observing a chemical reaction of the additive with the reactant, wherein the chemical reaction provides a visible color change and wherein the visible color change indicates presence of the additive.

Embodiments of the present disclosure include use of a porous fibrous air filtration medium, wherein the porous fibrous air filtration medium includes an impregnate capable of absorbing acid gases.

Methods of the present disclosure include methods for forming an impregnated fiber filtration medium and methods for monitoring or testing the utility of the filtration media so it can be replaced when the capacity for acid gas absorption becomes exhausted, thereby monitoring or testing utility of the impregnated fiber filtration medium.

The term “embodiment” and similar terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

### BRIEF DESCRIPTION OF THE DRAWINGS

The specification makes reference to the following appended figures, in which use of like reference numerals in different figures is intended to illustrate like or analogous components.

FIG. 1 is a cross-sectional schematic of a metal zeolite impregnated fiber filter according to certain aspects of the present disclosure.

FIG. 2 is a digital image of an exemplary fiber filter according to certain aspects of the present disclosure.

FIG. 3 is a digital image of an exemplary fiber filter according to certain aspects of the present disclosure.

FIG. 4 is a graph showing service life test results of an exemplary fiber filter according to certain aspects of the present disclosure.

FIG. 5 is a graph showing service life test results of an exemplary fiber filter according to certain aspects of the present disclosure.

FIG. 6 is a graph showing service life test results of an exemplary fiber filter according to certain aspects of the present disclosure.

FIG. 7 is a graph showing service life test results of an exemplary fiber filter according to certain aspects of the present disclosure.

### DETAILED DESCRIPTION

Certain aspects and features of the present disclosure relate to the formation and use of air filtration media, methods of treating a fluid stream with the media to remove one or more acid gases and/or ammonia contaminants, and methods for testing the filtration media utility for acid gas absorption ability. A fiber filtration media can be used to remove or reduce undesirable compounds, or contaminants, from a gaseous fluid stream. The fiber filtration media contains an impregnate, which is a metal zeolite. The impregnate preferably is, but does not have to be, applied to the air filtration media as a liquid impregnate solution.

### Filtration Media Production

Generally described, the filtration media provided herein contain a fiber network impregnated with an additive that is a metal zeolite. Preferred fiber networks include polymers, copolymers, and combinations thereof. Reference is made herein to U.S. Pat. No. 6,841,244, which is incorporated herein by reference in its entirety.

Methods for production of the filtration media are provided herein. The fiber networks are manufactured, or formed into fiber filters, according to U.S. Pat. No. 5,942,323, also incorporated herein by reference in its entirety. The fibers used herein can be a multi-layer fiber, wherein a first layer is a core and a second layer is a cladding about the core. Alternatively, the fibers can be a single layer composed of polymers, copolymers, glasses, organic materials, or inorganic materials. In one embodiment, the fiber contains a poly(ethylene terephthalate) (PET) core and a poly(cyclohexylenedimethylene terephthalate) (PCT) clad. Additives, including metal zeolites, are impregnated into the PCT clad. The additives can be incorporated into the clad during extrusion of a core-clad fiber. Optionally, the additives are incorporated into the clad after extrusion by melt impregnation (e.g., heat the core-clad fiber to about a melting point of the PCT clad, introduce the metal zeolite and cool the fiber allowing the PCT clad to solidify around the metal zeolite), solvent impregnation (e.g., immerse the core-clad fiber in a suitable solvent for the PCT clad, swell the PCT clad in the good solvent, introduce the metal zeolite, remove the fiber from the good solvent and allow the PCT clad to condense around the metal zeolite), or use of adhesives. The fiber size is preferably approximately from 0.7 dtex to 25 dtex in size (e.g., from 0.7 dtex to 20 dtex, from 1 dtex to 15 dtex, or from 5 dtex to 10 dtex). For example, the fiber size can be approximately 0.7 dtex, 0.8 dtex, 0.9 dtex, 1 dtex, 2 dtex, 3 dtex, 4 dtex, 5 dtex, 6 dtex, 7 dtex, 8 dtex, 9 dtex, 10 dtex, 11 dtex, 12 dtex, 13 dtex, 14 dtex, 15 dtex, 16 dtex, 17 dtex, 18 dtex, 19 dtex, 20 dtex, 21 dtex, 22 dtex, 23 dtex, 24 dtex, 25 dtex, or anywhere in between.

Preferred metal zeolites are silver zeolite, copper zeolite and/or a combination silver copper zeolite. In some examples, silver and copper present in the combination silver copper zeolite can be present in any weight ratio. For example, a silver to copper ratio (Ag:Cu) in the combination silver copper zeolite can be 0:100, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, or 100:0, or anywhere in between. All values are in weight percent (wt. %). In some cases, zeolites of tin and zinc can be used. The filtration media preferably includes approximately 0.2 to about 6.0% by weight of the additive. For example, the additive composition in the filtration media can be about 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3 wt. %, 3.1 wt. %, 3.2 wt. %, 3.3 wt. %, 3.4 wt. %, 3.5 wt. %, 3.6 wt. %, 3.7 wt. %, 3.8 wt. %, 3.9 wt. %, 4 wt. %, 4.1 wt. %, 4.2 wt. %, 4.3 wt. %, 4.4 wt. %, 4.5 wt. %, 4.6 wt. %, 4.7 wt. %, 4.8 wt. %, 4.9 wt. %, 5 wt. %, 5.1 wt. %, 5.2 wt. %, 5.3 wt. %, 5.4 wt. %, 5.5 wt. %, 5.6 wt. %, 5.7 wt. %, 5.8 wt. %, 5.9 wt. %, or 6 wt. %.

In some examples, zeolites that can be used in this media include, but are not limited to, amicite (hydrated potassium sodium aluminum silicate), analcime (hydrated sodium aluminum silicate), pollucite (hydrated cesium sodium aluminum silicate), boggsite (hydrated calcium sodium aluminum silicate), chabazite (hydrated calcium aluminum silicate), edingtonite (hydrated barium calcium aluminum silicate), faujasite (hydrated sodium calcium magnesium aluminum silicate), ferrierite (hydrated sodium potassium magnesium calcium aluminum silicate), gobbinsite (hydrated sodium potassium calcium aluminum silicate), harmotome (hydrated barium potassium aluminum silicate), phillipsite (hydrated potassium sodium calcium aluminum silicate), clinoptilolite (hydrated sodium potassium calcium aluminum silicate), mordenite (hydrated sodium potassium calcium aluminum silicate), mesolite (hydrated sodium calcium aluminum silicate), natrolite (hydrated sodium aluminum silicate), garronite (hydrated calcium aluminum silicate), perlialite (hydrated potassium sodium calcium strontium aluminum silicate), barrerite (hydrated sodium potassium calcium aluminum silicate), stilbite (hydrated sodium calcium aluminum silicate), thomsonite (hydrated sodium calcium aluminum silicate), and the like. Zeolites have many related phosphate and silicate minerals with cage-like framework structures or with similar properties as zeolites, which may also be used in place of, or along with, zeolites. These zeolite-like minerals include minerals such as kehoeite, pahasapaite, tiptopite, hsianghualite, lovdarite, viseite, partheite, prehnite, roggianite, apophyllite, gyrolite, maricopaite, okenite, tacharanite, tobermorite, and the like.

When applied to the filtration media, the metal zeolite improves or allows the media to remove or reduce undesirable compounds, or contaminants, from a gaseous fluid stream. In particular, the filtration media can remove one or more acid gases, ammonia gas, or a combination of these undesirable contaminant gases. Previously available air filtration media have been unable to effectively and efficiently achieve this level of acid gas filtration.

Methods of Impregnating Fiber Filters with Metal Zeolites

Terms such as “filtration media”, “adsorbent composition,” “chemisorbent composition,” and “impregnated fiber” are all interchangeable, and denote a substance that is capable of reducing or eliminating the presence of unwanted contaminants in fluid streams by contact of such a substance with the fluid stream. It is to be understood that the term “fluid” is defined as a liquid or gas capable of flowing, or moving in a particular direction, and includes gaseous, aqueous, organic containing fluids, and inorganic containing fluids.

As discussed above, the additive could be, but does not need to be, applied to the filtration media as a liquid additive solution. The liquid solution is sprayed onto the filtration media or is applied by other known methods.

Alternatively, the additive could be, but does not need to be, provided as a powder. The powder is applied directly to the filtration media, or water or another liquid is added to the powder to hydrate it prior to application of the additive composition onto the filtration media.

In addition, for extruded or cast filtration media (such as polymer fibers or non-woven polymer media), the additive is added directly to the polymer/copolymer material prior to its extrusion or casting. The additive is thus more evenly distributed throughout the media, in contrast to media on which a liquid additive has been sprayed onto its outer surface.

Briefly, a preferred method of making an extruded, or cast, additive impregnated multi-layer fibers includes heating a first polymer to form a first polymer melt and extruding the first polymer melt to form a first polymer fiber. A second polymer is heated to form a second polymer melt and the additive is mixed into the second polymer melt to form an additive containing polymer melt. The additive containing polymer melt is extruded about the first polymer fiber to form an additive containing clad layer, providing a core-clad polymer fiber having additives in the clad layer.

Specific methods of applying liquid or powder additive compositions onto air filtration media are known to those skilled in the art.

A filter can be provided by combining a plurality of fibers produced according to methods described herein. Individual fibers can be arranged such that the individual fibers are in contact and in random orientations to provide a porous membrane. Method of securing the porous membrane include, but are not limited to, use of adhesives, mounting fibers in a frame or partially melting the fibers and allowing the fibers to solidify as a homogenous network. In one embodiment, the porous membrane (i.e., the filter) is from about 5 mm to about 500 mm thick. In one embodiment, the porous membrane has a pore size from 50 nm to 100 μm.

Methods of Contaminant Removal from a Fluid Stream

Also provided is a method of treating a contaminated fluid stream using the dry scrubbing filtration media described herein. This method involves contacting the contaminated fluid stream with the filtration composition provided herein. Typically, the undesired contaminant (e.g., one or more gaseous acids, and/or, ammonia gas) is removed from air, especially from air admixed with effluent gas streams resulting from municipal waste treatment facilities, paper mills, petrochemical refining plants, morgues, hospitals, anatomy laboratories, hotel facilities, museums, archives, computer and data storage rooms, semiconductor fabrication facilities, other commercial and industrial facilities, diaper boxes (e.g., used to contain used reusable diapers) and litter boxes, to name a few. Methods of treating gaseous or other fluid streams using different media are well known in the art. Any method known in the art of treating fluid streams with the media described herein may be used.

Gaseous contaminants that can be removed from a fluid stream according to the methods described herein include, but are not limited to, acid gases such as gaseous sulfuric acid, gaseous nitric acid, gaseous perchloric acid, gaseous hydrochloric acid, gaseous hydroiodic acid, gaseous hydrobromic acid, gaseous iodic acid, gaseous bromic acid, chlorine gas, hydrogen sulfide, just to name a few, and/or gaseous ammonia.

Briefly, a core-clad polymer fiber filter composed of fibers containing a first polymer core, a second polymer clad and a metal zeolite additive impregnated in the second polymer clad can be placed in an air flow containing a gaseous acid. Not to be bound by theory, the metal zeolite component of the fibers can react with gaseous acids converting the metal zeolites to various inert compounds including, but are not limited to, metal sulfates, metal oxides, and water. Additionally, the core-clad fiber filter can be placed in an air flow containing ammonia gas. The ammonia gas can be absorbed by the porous membrane as described above, further providing removal of ammonia gas from the air flow.

### Methods of Testing Filter Utility

Also provided herein is a method for testing the impregnated filtration media for continued usability. The metal zeolites impregnated into and/or onto the fiber filter can be reacted with any suitable reactant to induce a color change of the metal zeolite. In some examples, introducing, reacting, bringing into contact or applying liquid or aerosol ammonia to a copper zeolite will cause a color change from a colorless (white) color to a blue color. Evidence of the reaction (blue color) indicates copper zeolite continues to be present in the fiber filter and capable of filtering acid gases from an air flow. A lack of color change from colorless (white) to blue indicates the fiber filter is no longer capable of filtering acid gases from an air flow.

In another embodiment, impregnating metal zeolites, preferably copper zeolites, into a fiber filter provides a life-testable fiber filter (i.e., usability of the impregnated fiber filter can be evaluated). Copper zeolite impregnated fiber filters have a white color. Exploiting a reaction between Cu(II) ions and a suitable reactant, including liquid or aerosol ammonia (NH₃), provides a copper-ammonia complex having a distinct blue color. As liquid or aerosol ammonia is added to a solution of copper (II) ions, a complex will form between the ammonia molecules and copper (II) ions, dissolving the copper hydroxide precipitate that initially forms to form a deep-blue solution, Cu(NH₃)₄²⁺. Ammonia molecules can attach one at a time, and in between each attachment, there is a chemical equilibrium. As more liquid or aerosol ammonia is added, more complex is formed, and the equilibrium is pushed to the product side. Such a transition from white to blue indicates a presence of copper in the fiber filter, thus indicating the fiber filter is still useable for removal of acid gases from an air flow. Exploiting a reaction between Cu(II) ions with liquid or aerosol ammonia (NH₃) provides copper-ammonia complexes having a distinct blue color. Such a transition from white to blue indicates a presence of copper in the fiber filter, thus indicating the fiber filter is still useable for removal of acid gases from an air flow.

In some non-limiting examples, contacting the reactant (e.g., the liquid or aerosol ammonia) with the fiber filter can include spraying the reactant (e.g., an ammonia solution aerosol, or an ammonia solution), applying the reactant (e.g., the ammonia solution) to the fiber filter with an applicator (e.g., a sponge or cotton-tipped swab), applying the reactant (e.g., the ammonia solution) to the fiber filter with a cloth, applying the reactant (e.g., the ammonia solution) to the fiber filter with a dropper or brush, or any combination thereof, or any suitable method to contact a reactant to a solid (e.g., to effect a visually-detectable chemical reaction). For example, an ammonia solution can be applied to the impregnated filtration media with an eye dropper, a spray bottle, or any suitable liquid delivery device. In some cases, liquid or aerosol ammonia can be applied to a small portion of the impregnated filtration media for testing. The small portion can be of any suitable shape, including circular, elliptical, spherical, square, rectangular, cubic, triangular, polygonal, polyhedral, or any combination thereof. The small portion can have any area less than a total area of the impregnated filtration media. For example, the small portion can have an area of from about 2.5 cm² to about 10 cm² (e.g., about 2.5 cm², 3.0 cm², 3.5 cm², 4.0 cm², 4.5 cm², 5.0 cm², 5.5 cm², 6.0 cm², 6.5 cm², 7.0 cm², 7.5 cm², 8.0 cm², 8.5 cm², 9.0 cm², 9.5 cm², or 10.0 cm²). The small portion can have any volume less than a total volume of the impregnated filtration media. For example, the small portion can have a volume of from about 5.0 cm³ to about 15.0 cm³ (e.g., about 5.0 cm³, 5.5 cm³, 6.0 cm³, 6.5 cm³, 7.0 cm³, 7.5 cm³, 8.0 cm³, 8.5 cm³, 9.0 cm³, 9.5 cm³, 10.0 cm³, 10.5 cm³, 11.0 cm³, 11.5 cm³, 12.0 cm³, 12.5 cm³, 13.0 cm³, 13.5 cm³, 14.0 cm³, 14.5 cm³, or 15.0 cm³. Ammonia solution can be applied to the small portion of the impregnated filtration media in a volume of from about 0.25 mL to about 1.0 mL. For example, about 0.25 mL, about 0.5 mL, about 0.75 mL, or about 1.0 mL of ammonia solution can be applied to the impregnated filtration media. Reacting the impregnated filtration media with liquid or aerosol ammonia can be complete in a time of from about 3 minutes to about 15 minutes. In other words, a visible color change can be evident in about 3 minutes, 4 minutes, 5 minutes, 6 minutes, 7 minutes, 8 minutes, 9 minutes, 10 minutes, 11 minutes, 12 minutes, 13 minutes, 14 minutes, or 15 minutes after applying the liquid or aerosol ammonia.

Under the circumstances and conditions specified above, the act of contacting a fiber filter, capable of removing acid gases, with liquid or aerosol ammonia will induce a color change. For example, contacting the fiber filter with liquid or aerosol ammonia will induce a color change when the copper zeolite is present in the fiber filter. The fiber filter can still be used to remove gaseous acids from an air flow when the copper zeolite is present.

Alternatively, in some cases, contacting liquid or aerosol ammonia to the fiber filter will not produce a visible color change. For example, contacting liquid or aerosol ammonia to the fiber filter will not produce a visible color change when the copper zeolite is depleted or otherwise not present in the fiber filter (e.g., the copper zeolite is exhausted). The fiber filter cannot remove gaseous acids from an air flow when the copper zeolite is absent.

Contacting the fiber filter with liquid or aerosol ammonia where the copper zeolite is present in the fiber filter can produce a color change from white (e.g., RGB values of 255, 255, 255) to a blue color (e.g., RGB values of 0, 0, 255, referred to as “pure blue”). The blue color can be any blue color across a gradient from a very light blue (e.g., RGB values of 240, 240, 255) to pure blue. Not to be bound by theory, a degree of blue can be determined by an amount of copper zeolite present in the fiber filter, an amount of liquid or aerosol ammonia applied to the fiber filter where the copper zeolite is present, or a combination thereof. In some examples, the color change can be interpreted in a binary manner, wherein no color change indicates a spent fiber filter and any color change indicates the fiber filter can still filter acid gases from the air flow. In some further examples, the degree of blue can be interpreted in a manner to predict any remaining usefulness of the fiber filter. For example, a darker blue (e.g., RGB values of 50, 50, 255) can indicate a longer remaining service lifetime, and a lighter blue (e.g., RGB values of 200, 200, 255) can indicate a shorter remaining service lifetime. In some cases, a test kit can be provided with the fiber filter as described herein. The test kit can include a liquid or aerosol ammonia applicator, and a comparative color guide to estimate the remaining service lifetime of the fiber filter.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

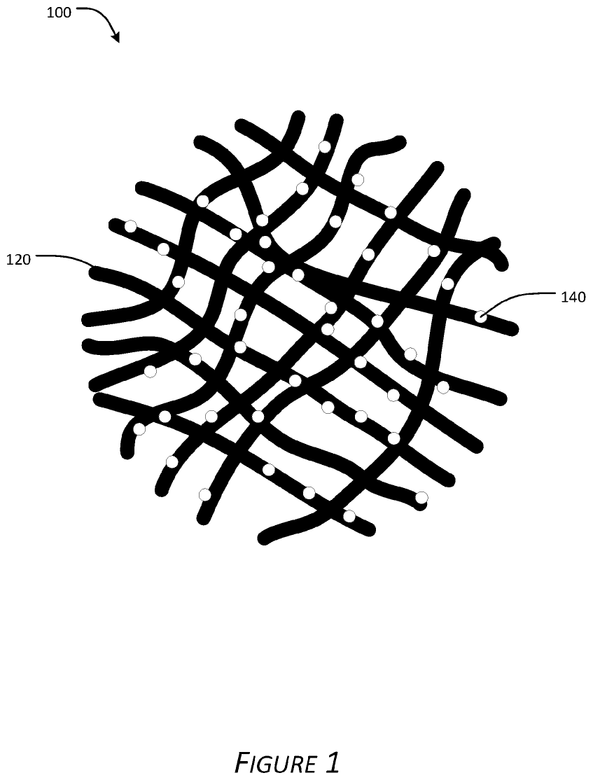

FIG. 1 presents a cross-sectional schematic representation of a fiber filter media 100 (e.g., a network of fibers providing a fiber filter) impregnated with metal zeolite particles. Polymer/copolymer fibers 120 are formed into a network. Metal zeolite particles 140 are impregnated into and/or onto the fibers via methods described herein. Fluid flow is normal to the drawing sheet.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

### EXAMPLES

### Example 1

Example 1 is a method for removing gaseous acids from a fluid stream by filtering the fluid stream with a filtration medium as described herein. A core-clad polymer fiber filter composed of a PET core, a PCT clad and a copper zeolite additive impregnated in the PCT clad can be placed in an air flow containing sulfuric acid (H₂SO₄). Not to be bound by theory, the copper (Cu) zeolite component of the filtration media can react with gaseous H₂SO₄ according to formula (I):

Cu+2H₂SO₄→CuSO₄+SO₂+2H₂O

The gaseous sulfuric acid can thus be converted to copper sulfate, sulfur dioxide and water.

### Example 2

Example 2 is a method for removing gaseous acids from a fluid stream by filtering the fluid stream with a filtration medium as described herein. A core-clad polymer fiber filter composed of a PET core, a PCT clad and a silver zeolite additive impregnated in the PCT clad can be placed in an air flow containing nitric acid (HNO₃). Not to be bound by theory, the silver (Ag) zeolite component of the filtration media can react with gaseous HNO₃ according to formula (II):

3Ag+4HNO₃→3AgNO3+NO+2H₂O

The gaseous nitric acid can thus be converted to silver nitrate, nitric oxide and water.

### Example 3

Example 3 is a method for analyzing unconverted metal zeolite (i.e., remaining usability) of the filtration medium as described herein. As produced, the filtration medium is white in color. A filtration medium, as described herein that has been in service, is sprayed with an ammonia aerosol. Any available copper zeolite reacts with the ammonia resulting in a visible blue color. Observation of a color change from white to blue indicates to a user that the filter is still usable. The filter remaining white after contact with the ammonia indicates to a user the gaseous acid filter must be replaced.

A test kit can be made available to an end user or a technician. The test kit can include an ammonia solution, a method of delivering the ammonia solution (e.g., an aerosol can, a wash bottle, or an applicator), and a reference guide. The reference guide can be an indicator that is a color gradient printed on a material such as paper or a poly(ethylene terephthalate) film wherein the color gradient traverses from white to blue (e.g., a blue color gradient). For example, steps of the color gradient can include red, green and blue (RGB) values of (255, 255, 255; i.e., white), (230, 230, 255), (205, 205, 255), (180, 180, 255), (155, 155, 255), (130, 130, 255), (105, 105, 255), (80, 80, 255), (55, 55, 255), (30, 30, 255), and (0, 0, 255; i.e., pure blue). The steps of the color gradient can correspond to the color of the filtration media after contact with the ammonia solution. In some aspects, white ((255, 255, 255) can indicate the metal zeolite is absent and blue (0, 0, 255) can indicate the metal zeolite is present in the filtration media and the filtration media can still be used to filter gaseous acids from an air flow.

### Example 4

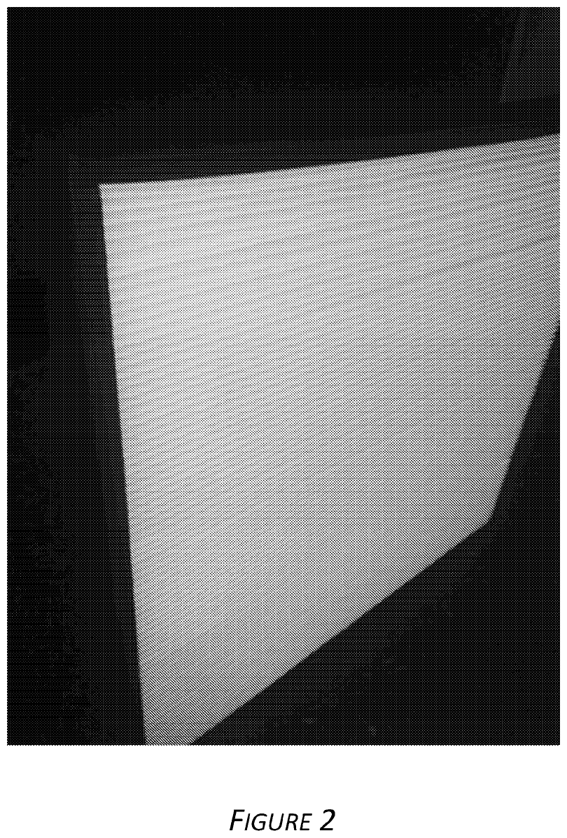

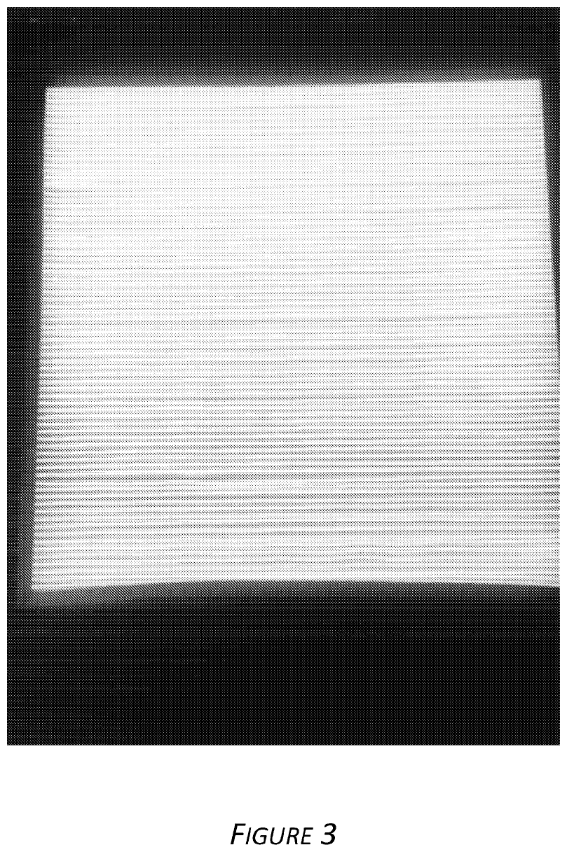

Example 4 is a field test performed at an exit of a sewer main. Two exemplary filters employing the Cu zeolite were used in the field test. A two-inch (2″) pleated filter (see FIG. 2) and a 2″ mini-pleated filter (see FIG. 3) were placed in an air flow emanating from the exit of the sewer main. Hydrogen sulfide (H₂S) was measured upstream and downstream of each filter to evaluate H₂S removal from the air flow. For the 2″ pleated filter (see FIG. 2), H₂S content in the air flow was 0.75 parts per million (ppm) upstream of the 2″ pleated filter and 0.65 ppm downstream of the 2″ pleated filter. For the 2″ mini-pleated filter (see FIG. 3), H₂S content in the air flow was 0.75 ppm upstream of the 2″ mini-pleated filter and 0.35 ppm downstream of the 2″ mini-pleated filer. Both filters exhibited removal of H₂S from the air flow. The 2″ mini-pleated filter removed more H₂S from the air flow due to a higher filtration media surface area compared to the 2″ pleated filter.

### Example 5

Example 5 is a laboratory test conducted to evaluate ammonia filtration of the exemplary fiber filter. Test samples were prepared by cutting 130.7 cm² samples from a prepared pleated fiber filter (see FIG. 2). The samples were flattened to remove pleating and mounted in a test fixture having a 79.2 cm² opening. The samples were then conditioned by holding the samples in an environment having a temperature of 23° C. and a relative humidity of 85% until upstream and downstream flow equilibrated. A gas stream containing 30 ppm ammonia gas was passed through the samples at a rate of 12.7 liters per minute (LPM). Ammonia concentration was measured downstream of the samples. Ammonia break through (i.e., ammonia not being filtered) was determined to occur when the ammonia concentration downstream of the samples was 27 ppm. Time in minutes of the ammonia break through was recorded and capacity of ammonia captured by the samples was measured are reported as mass per unit area of the samples (mg/cm²). Test results are summarized in Table 1 below:

TABLE 1

| | Break Through Time | Capacity at Break Through |
|---|---|---|
| Sample No. | (min) | (mg/cm²) |
| 1 | 36 | 0.1 |
| 2 | 45 | 0.2 |
| 3 | 40 | 0.1 |
| 4 | 37 | 0.1 |

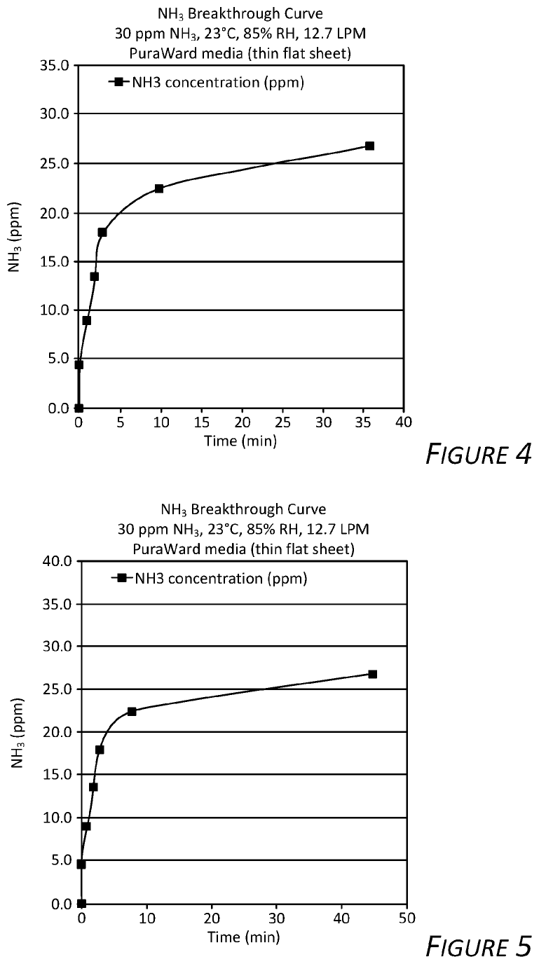

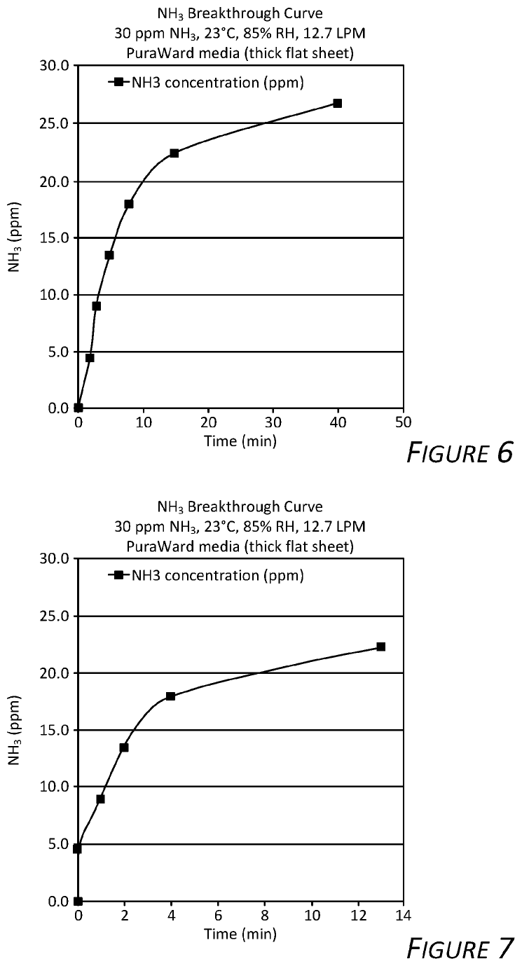

FIGS. 4, 5, 6, and 7 are graphs showing downstream ammonia concentration versus time for the samples described above. Evident in the graphs, ammonia filtration is effective until the fiber filter filtration media becomes saturated and is most effective just before break through.

All patents, publications and abstracts cited above are incorporated herein by reference in their entireties. Various embodiments of the invention have been described in fulfillment of the various objectives of the invention. It should be recognized that these embodiments are merely illustrative of the principles of the present invention. Numerous modifications and adaptions thereof will be readily apparent to those skilled in the art without departing from the spirit and scope of the present invention as defined in the following claims.

What is claimed is:

1. A method for removing one or more gaseous contaminants from a fluid stream, wherein the one or more gaseous contaminants comprise gaseous acids, comprising contacting the fluid stream with a filtration medium comprising:
a multi-layer fiber, wherein a first layer is a core and a second layer is a cladding, and an additive is disposed within the cladding.

2. The method of claim 1, wherein the gaseous acids to be removed comprise hydrogen sulfide, sulfuric acid, nitric acid, perchloric acid, ammonia, or chlorine gas.

3. The method of claim 1, wherein the core of the multi-layer fiber is poly(ethylene terephthalate) (PET) and the cladding is poly(cyclohexylenedimethylene terephthalate) (PCT).

4. The method of claim 1, wherein the additive comprises a zeolite of a metal chosen from the group consisting of silver, copper, and a combination thereof.

5. The method of claim 1, wherein the multi-layer fiber comprises 0.2-6.0 wt.-% of the additive.

6. A method of making additive impregnated multi-layer fibers comprising:
heating a first polymer to form a first polymer melt;
extruding the first polymer melt to form a first polymer fiber;
heating a second polymer to form a second polymer melt;
mixing an additive comprising a metal zeolite into the second polymer melt to form an additive-containing polymer melt; and
extruding the additive-containing polymer melt about the first polymer fiber to form an additive-containing fiber layer, wherein the first polymer fiber is a core and the additive-containing fiber layer is a cladding.

7. The method of claim 6, wherein the first polymer comprises poly(ethylene terephthalate) (PET); and wherein the second polymer comprises poly(cyclohexylenedimethylene terephthalate) (PCT).

8. The method of claim 6, wherein the additive is a metal zeolite.

9. The method of claim 6, wherein the additive comprises a zeolite of a metal chosen from the group consisting of silver, copper and a combination thereof.

10. The method of claim 6, wherein a plurality of additive impregnated multi-layer fibers is combined to provide a filter.

11. The method of claim 10, wherein the filter comprises a network of multi-layer fibers disposed mutually adjacent and in random orientations such that a porous membrane is formed.

12. A method for analyzing ability of an unconverted metal zeolite of a filtration medium to continue to remove gaseous acids from a fluid stream, wherein the filtration medium comprises a multi-layer fiber, wherein a first layer is a core and a second layer is a cladding, and an additive is disposed within the cladding, comprising:
contacting the filtration medium with a reactant; and
observing a chemical reaction of the additive with the reactant, wherein the chemical reaction provides a visible color change and wherein the visible color change indicates presence of the additive.

13. The method of claim 12, wherein the core of the multi-layer fiber is poly(ethylene terephthalate) (PET) and the cladding is poly(cyclohexylenedimethylene terephthalate) (PCT).

14. The method of claim 12, wherein the additive comprises a zeolite.

15. The method of claim 14, wherein the zeolite is copper.

16. The method of claim 12, wherein the reactant comprises ammonia.

17. The method of claim 16, wherein the ammonia is in a state chosen from the group consisting of a solution and an aerosol.

18. The method of claim 12, wherein contacting the filtration medium with the reactant comprises spraying the reactant onto the filtration medium.

19. The method of claim 12, wherein the visible color change is evaluated against a white to blue color gradient.

20. The method of claim 12, wherein white indicates no visible color change, and no visible color change indicates the additive is absent, and blue indicates a visible color change, and visible color change indicates the additive is present.
